(19) United States
(12) Patent Application Publication
(10) Pub. No.: US 2008/0003007 A1
(43) Pub. Date: Jan. 3, 2008

(54) Method and apparatus for controlling fusing temperature, and image forming apparatus

(75) Inventor: Jae-hyeok Jang, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/636,632

(22) Filed: Dec. 11, 2006

(30) Foreign Application Priority Data
Jun. 29, 2006 (KR) 2006-59241

(51) Int. Cl. G03G 15/20

(52) U.S. Cl. 399/69

(57) ABSTRACT

A method and apparatus for controlling a fusing temperature, and an image forming apparatus are provided. In the method of controlling a fusing temperature, power is supplied to a heat source included inside a heat roller at on/off chopping rates determined according to the temperature of the heat roller during a time period in which the temperature of the heat roller is rising, and power is supplied to the heat source at on/off chopping rates which are respectively increased by a predetermined value with respect to the determined on/off chopping rates during a time period in which the temperature of the heat roller is falling. Accordingly, a fusing property can be prevented from degrading in an initial printing process after a cold start occurs in a fusing unit, and thus a first print out time (FPOT) can be reduced.

### CROSS-REFERENCE TO RELATED PATENT APPLICATION

This application claims the benefit under 35 U.S.C. §119(a) of Korean Patent Application No. 10-2006-0059241, filed on Jun. 29, 2006, in the Korean Intellectual Property Office, the entire disclosure of which is hereby incorporated by reference.

### BACKGROUND OF THE INVENTION

1. Field of the Invention

The present invention relates to a method and apparatus for controlling a fusing temperature, and an image forming apparatus. More particularly, the present invention relates to a method and apparatus for controlling a fusing temperature of a fusing unit that includes a heat roller, which transmits heat to a toner image formed on a printing medium, and a heat source which receives power and which is included inside the heat roller, and an image forming apparatus.

2. Description of the Related Art

Electro-photographic image forming apparatuses include fusing units to heat printing mediums on which toner images are transferred, so that the toner images formed on the printing mediums in a powder state are temporarily melted. This facilitates the fixation of the images onto the printing medium. The fusing unit includes a heat roller which fixes toner onto a sheet of paper, and a pressure roller which tightens the printing medium against the heat roller so that the printing medium is pressed against the heat roller and is thereby supported.

FIG. 1 is a schematic horizontal cross-sectional view of a conventional heat roller. FIG. 2 is a schematic vertical cross-sectional view of a fusing unit using the heat roller illustrated in FIG. 1.

Referring to FIG. 1, a heat roller 10 includes a cylindrical roller 11 and a heater lamp 12 that is disposed along the center of the cylindrical roller 11. A coating layer 11a of Teflon is formed on the surface of the cylindrical roller 11. The heater lamp 12 generates heat inside the roller 11, and the roller 11 is heated by radiant heat from the heater lamp 12.

Referring to FIG. 2, a pressure roller 13 is disposed below the heat roller 10 so that the pressure roller 13 faces the heat roller 10 with a printing medium 14 being interposed between the heat roller 10 and the pressure roller 13. The pressure roller 13 is elastically supported by a spring 13a, and allows the printing medium 14 passing between the heat roller 10 and the pressure roller 13 to be closely adhered to the heat roller 10 due to pressure. In this case, the printing medium 14, on which a toner image 14a of a powder state is formed, is fixed onto the printing medium 14 by pressure and heat while passing between the heat roller 10 and the pressure roller 13.

One side of the heat roller 10 is provided with a thermistor 15 and a thermostat 16. The thermistor 15 measures the surface temperature of the heat roller 10 and the thermostat 16 disconnects power supplied to the heater lamp 12 when the surface temperature exceeds a predetermined setting value. The thermistor 15 measures the surface temperature of the heat roller 10, and then transmits a measured electrical signal to a determining unit (not shown) of an image forming apparatus (not shown). The determining unit controls power supplied to the heater lamp 12 according to the measured temperature, and maintains the surface temperature of the cylindrical roller 11 to be within a predetermined range. If the thermistor 15 and the determining unit cannot control the temperature of the heat roller 10, the temperature of the heat roller 10 may exceed a critical setting value which results in the opening of a contact (not shown) of the thermostat 16, and thus the thermostat 16 disconnects power supplied to the heater lamp 12.

In the conventional method of controlling fusing temperature, the temperature of a heat roller is measured. Furthermore, an on/off chopping rate for voltage supplied to a heater lamp varies depending on a temperature range where the temperature is measured, thereby increasing or decreasing power supplied to the heater lamp.

The conventional fusing unit comprises a heat roller that includes one heater lamp. In this conventional fusing unit, a motor driving time period is set to be in the range of 10 to 15 seconds in order to ensure an initial fusing property in the case of a cold start, that is, in situations where a printing instruction is received after power is supplied or when in a sleep mode. Therefore, a fusing temperature is reached after a significantly long warm-up time elapses, and thus there is a relatively long first print out time (FPOT).

The use of two lamps or the use of one heater lamp consuming a relatively high amount of power results in a temperature rising speed and prevents the requirement that the motor driving time period must be set. Thus, a warm-up time is reduced. In order to reduce the FPOT, when printing is carried out immediately after the fusing temperature has been reached, the fusing property is ensured for a first sheet of paper. However, in this case, large overshoot is produced, and immediately thereafter, a temperature-falling time period is present. In general, second through fifth sheets of paper are printed during the temperature-falling time period, and the fixing property is significantly degraded since heat is absorbed by a printing medium, toner, and a pressure roller, among others. The conventional method in which the on/off chopping rate for a voltage supplied to the heater lamp simply varies depending on an area in which the temperature is measured, cannot prevent the fusing property from degrading during the temperature-falling time period.

Accordingly, there is a need for an improved system and method for controlling a fusing temperature to prevent a fusing property from degrading in an initial printing process.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus for controlling a fusing temperature, in which a fusing property can be prevented from degrading in an initial printing process after a cold start occurs while reducing a first print out time (FPOT), and an image forming apparatus.

According to an aspect of an exemplary embodiment of the present invention, a method of controlling a fusing temperature of a fusing unit is provided. A heat roller transmits heat to a toner image formed on a printing medium and a heat source which is included inside the heat roller and to which power is supplied. Power is supplied to the heat source at on/off chopping rates determined according to the temperature of the heat roller during a time period in which the temperature of the heat roller is rising. Power is also supplied to the heat source at on/off chopping rates which are respectively increased by a predetermined value with respect to the determined on/off chopping rates, during a time period in which the temperature of the heat roller is falling.

Power is supplied to the heat source at on/off chopping rates determined based on the temperature of the heat roller during the time period in which the temperature of the heat roller is rising to control fusing temperature. The on/off chopping rates may be determined to be decreased as the temperature of the heat roller increases.

When power is supplied to the heat source at on/off chopping rates which are respectively increased by a predetermined value with respect to the determined on/off chopping rates, during a time period in which the temperature of the heat roller is falling, the increased on/off chopping rates may be determined to be increased as the temperature of the heat roller decreases.

When power is supplied to the heat source at on/off chopping rates determined according to the temperature of the heat roller during a time period in which the temperature of the heat roller is rising, when the temperature of the heat roller is above a predetermined target temperature required for fusing, power may be not supplied to the heat source.

When power is supplied to the heat source at on/off chopping rates which are respectively increased by a predetermined value with respect to the determined on/off chopping rates, during a time period in which the temperature of the heat roller is between the predetermined target temperature required for fusing and a predetermined temperature greater than the target temperature, power may be supplied to the heat source at a predetermined on/off chopping rate.

When power is supplied to the heat source at on/off chopping rates which are respectively increased by a predetermined value with respect to the determined on/off chopping rates, during a time period in which the temperature of the heat roller is falling, power may be supplied to the heat source at the increased on/off chopping rates only when the number of sheets printed since a cold start occurred in the fusing unit is within a predetermined number.

When power is supplied to the heat source at on/off chopping rates which are respectively increased by a predetermined value with respect to the determined on/off chopping rates, during a time period in which the temperature of the heat roller is falling, power may be supplied to the heat source at the increased on/off chopping rates only when an elapsed time after the temperature of the heat roller reaches the predetermined target temperature required for fusing is within a predetermined time.

According to another aspect of an exemplary embodiment of the present invention, an apparatus for controlling fusing temperature of a fusing unit is provided that includes a heat roller and a heat source. The heat roller transmits heat to a toner image formed on a printing medium and the heat source is included inside the heat roller and receives power. The apparatus comprises a determining unit and a power supply. The determining unit determines on/off chopping rates according to the temperature of the heat roller during a time period in which the temperature of the heat roller is rising, and determines on/off chopping rates to be respectively increased by a predetermined value with respect to the determined on/off chopping rates during a time period in which the temperature of the heat roller is falling. The power supply supplies power to the heat source according to the determined on/off chopping rates.

The determining unit may determine the on/off chopping rates to be decreased as the temperature of the heat roller increases during a time period in which the temperature of the heat roller is rising.

The determining unit may also determine the increased on/off chopping rates to be increased as the temperature of the heat roller decreases during a time period in which the temperature of the heat roller is falling.

The determining unit may also determine an on/off chopping rate to be 0% when the temperature of the heat roller is above the predetermined target temperature required for a fusing, during a time period in which the temperature of the heat roller is rising.

In addition, the determining unit may determine an on/off chopping rate to be a specific rate when the temperature of the heat roller is between the predetermined target temperature required for fusing and a predetermined temperature greater than the target temperature.

The apparatus for controlling fusing temperature may also comprise a counter that counts the number of sheets printed since a cold start occurred in the fusing unit, wherein the determining unit determines the increased on/off chopping rates only when the number of sheets printed is below a predetermined number.

In addition, the apparatus for controlling fusing temperature may further comprise a timer that outputs the length of an elapsed time after the temperature of the heat roller reaches the predetermined target temperature required for fusing, wherein the determining unit determines the increased on/off chopping rates only when the elapsed time is within a predetermined time.

According to another aspect of an exemplary embodiment of the present invention, an image forming apparatus for controlling a fusing temperature of a fusing unit is provided. The image forming apparatus includes a heat roller which transmits heat to a toner image formed on a printing medium and a heat source which is included inside the heat roller and to which power is supplied. The apparatus comprises a determining unit and a power supply. The determining unit determines on/off chopping rates according to the temperature of the heat roller during a time period in which the temperature of the heat roller is rising, and determines on/off chopping rates to be respectively increased by a predetermined value with respect to the determined on/off chopping rates during a time period in which the temperature of the heat roller is falling. The power supply supplies power to the heat source according to the determined on/off chopping rates.

The determining unit of the image forming apparatus for controlling fusing temperature may determine the on/off chopping rates to be decreased when the temperature of the heat roller increases during a time period in which the temperature of the heat roller is rising. The determining unit may also determine the increased on/off chopping rates to be increased when the temperature of the heat roller decreases during a time period in which the temperature of the heat roller is falling.

Also, the determining unit may determine an on/off chopping rate to be 0% when the temperature of the heat roller is above the predetermined target temperature required for fusing, during a time period in which the temperature of the heat roller is rising.

The determining unit may determine an on/off chopping rate to be a specific rate when the temperature of the heat roller is between the predetermined target temperature required for fusing and a predetermined temperature greater than the target temperature.

The image forming apparatus may further comprise a counter that counts the number of sheets printed since a cold start occurred of the image forming apparatus, wherein the determining unit determines the increased on/off chopping rates only when the number of sheets printed is below a predetermined number.

The image forming apparatus may further comprise a timer that outputs the length of an elapsed time after the temperature of the heat roller reaches the predetermined target temperature required for fusing, wherein the determining unit determines the increased on/off chopping rates only when the elapsed time is within a predetermined time.

Other objects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings in which:

FIG. 1 is a schematic horizontal cross-sectional view of a conventional heat roller;

FIG. 2 is a schematic vertical cross-sectional view of a fusing unit using the heat roller illustrated in FIG. 1;

FIG. 3 illustrates waveform diagrams of a voltage supplied to a heat lamp at different on/off chopping rates according to an exemplary embodiment of the present invention;

FIG. 4 is a block diagram of an apparatus for controlling a fusing temperature according to an exemplary embodiment of the present invention;

FIG. 5 is a table illustrating examples of on/off chopping rates for each temperature range of a heat roller, according to which a determining unit illustrated in FIG. 4 determines the on/off chopping rates;

FIG. 6 is a graph illustrating on/off chopping rates which are determined based on the table illustrated in FIG. 5 with respect to changes in the temperature of a heat roller over a certain period of elapsed time; and

FIG. 7 is a flowchart of a method of controlling a fusing temperature according to an exemplary embodiment of the present invention.

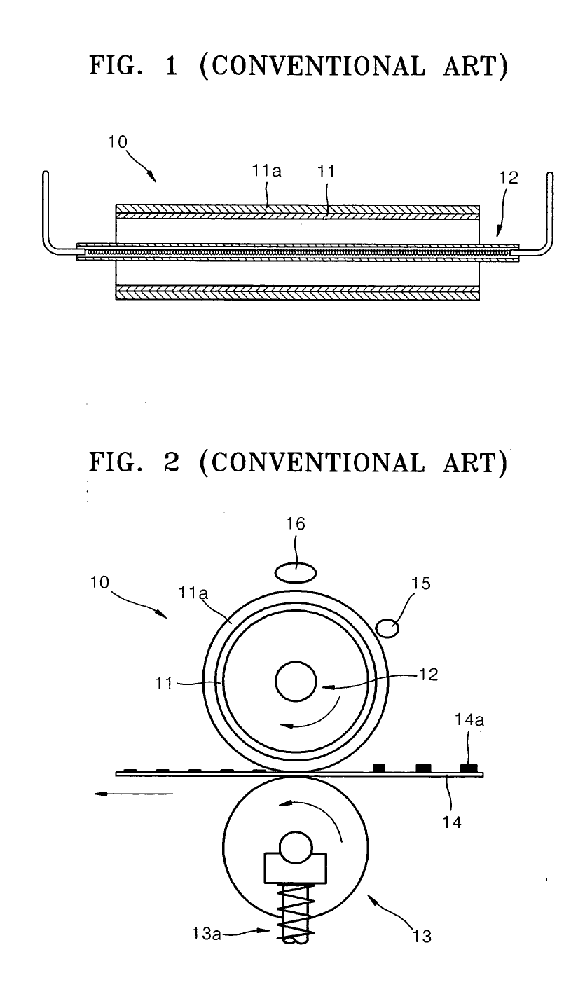

Throughout the drawings, the dame drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A heat lamp will be exemplified as a heat source, which is included inside a heat roller and to which power is supplied.

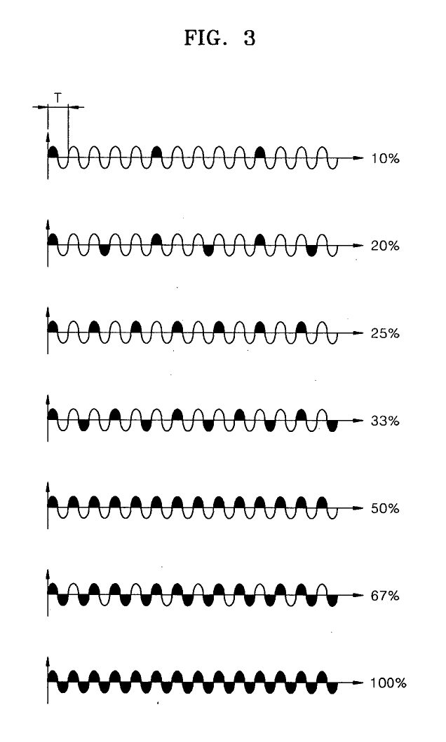

FIG. 3 illustrates waveform diagrams of a voltage supplied to a heat lamp at different on/off chopping rates.

Referring to FIG. 3, the voltage is supplied to the heater lamp at respective on/off chopping rates of 10%, 20%, 25%, 33%, 50%, 67%, and 100%. In comparison with maximum power supplied to the heater lamp, power is supplied according to each on/off chopping rate. Shaded portions of half of a period (T/2) shown in each waveform indicate a time required for supplying a source voltage to the heater.

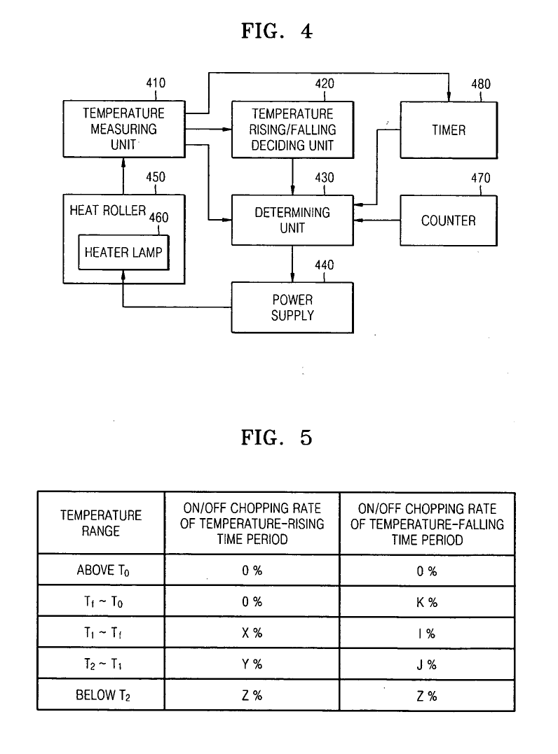

FIG. 4 is a block diagram of an apparatus for controlling a fusing temperature according to an exemplary embodiment of the present invention.

Referring to FIG. 4, the apparatus for controlling a fusing temperature includes a temperature measuring unit 410, a temperature rising/falling deciding unit 420, a determining unit 430, a power supply 440, a heat roller 450, a heater lamp 460 included inside the heat roller 450, a counter 470 that counts the number of printing sheets, and a timer 480.

The temperature measuring unit 410 measures the surface temperature of the heat roller 450, and outputs the measured temperature by periods.

The temperature rising/falling deciding unit 420 compares the measured temperature with a previously measured temperature to decide whether the surface temperature of the heat roller 450 is rising or falling, and outputs the result.

The counter 470 counts the number of printing sheets since a cold start occurs in the fusing unit, and outputs the result. The cold start means that a printing instruction is initially received after power is supplied to an image forming apparatus, or a printing instruction is received when the image forming apparatus is in a sleep mode.

The timer 480 receives a temperature value obtained by the temperature measuring unit 410, and outputs a time that has elapsed after the temperature of the heat roller reaches a target temperature required for fusing.

The determining unit 430 determines an on/off chopping rate of power to be supplied to the heater lamp 460 according to the measured temperature and a result output from the temperature rising/falling deciding unit 420, and outputs a signal corresponding thereto.

The power supply 440 receives the signal output from the determining unit 430, and supplies power to the heater lamp 460 at the determined on/off chopping rate.

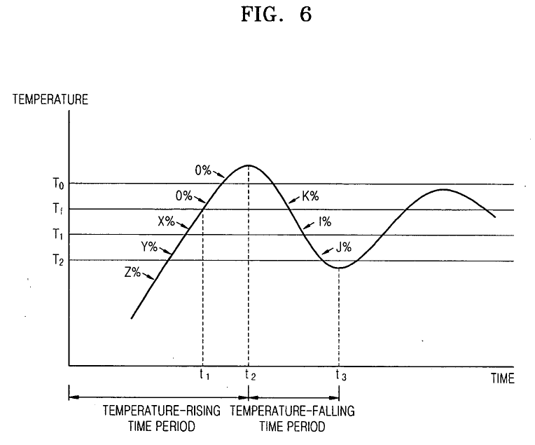

FIG. 5 is a table illustrating examples of on/off chopping rates for each temperature range of the heat roller 450. The determining unit 430 determines the on/off chopping rates based on on/off chopping rates for each temperature range of the heat roller 450. FIG. 6 is a graph illustrating on/off chopping rates which are determined on the basis of the table of FIG. 5 with respect to changes in the temperature of the heat roller 450 according to an elapsed period of time.

Referring to FIGS. 5 and 6, Tf denotes a fusing target temperature, and has the relation T2<T1<Tf<T0.

When the temperature T of the heat roller is below T2, power is supplied to the heater lamp at the on/off chopping rate of Z %. If T2<T<T1, the supplied on/off chopping rate is Y % during the temperature-rising time period, and J % during the temperature-falling time period. If T1<T<Tf, the supplied on/off chopping rate is X % in the temperature-rising time period, and 1% in the temperature-falling time period. This is related as Z≧Y≧X and K≦I≦J≦Z. During the temperature-rising time period, the on/off chopping rate decreases as temperature rises. During the temperature-falling time period, the on/off chopping rate increases as temperature decreases.

The on/off chopping rate is set differently for the temperature-rising time period and the temperature-falling time period even in the same temperature range. In the same temperature range, such as Y≦J and X≦I, the on/off chopping rate in the temperature-falling time period is determined to be above that of the temperature-rising time period. On/off chopping rates of the temperature-falling time period are determined to be equal to rates greater by a predetermined value than those of the temperature-rising time period in the same temperature range. Of course, in some temperature range, the temperature-falling time period and the temperature-rising time period may have the same on/off chopping rates as each other. In FIG. 5, the temperature-falling time period and the temperature-rising time period have the same on/off chopping rate when the temperature range is below T2. Specific values of on/off chopping rates for each temperature range, and the magnitude of rates, which increase for each temperature range, may vary depending on capacity of the heater lamp, and thermal capacity of units to be heated, such as the heat roller and the pressure roller.

Referring to FIG. 6, a first sheet of paper is printed after a time t1 at which the surface temperature of the heat roller reaches the fusing target temperature Tf. Second and third sheets of paper are printed while the temperature is falling after a time t2 at which overshoot is at a maximum. If the on/off chopping rate of the temperature-falling time period is above the on/off chopping rate of the temperature-rising time period in the same temperature range, a fusing property can be prevented from degrading when a heat supply is not sufficient while the temperature is falling after overshoot occurs.

Referring to FIGS. 5 and 6, when a temperature T of the heat roller is greater than the fusing target temperature Tf, an on/off chopping rate is determined to be 0% in the temperature-rising time period, and thus power is not supplied to the heater lamp. Alternatively, when the temperature T of the heat roller is related as Tf<T<T0 in the temperature-falling time period, that is, until reaching a predetermined temperature T0 greater than the fusing target temperature Tf, the on/off chopping rate is determined to be K %, and thus power is supplied to the heater lamp. Accordingly, when power is supplied to the heater lamp in a specific temperature range above the fusing target temperature while temperature is falling, the supply of power can be prevented from being delayed due to a separation distance in the surface of the heat roller 450 between a portion in which temperature is measured by the temperature measuring unit 410 and a portion in which fusing is performed on the printing medium. The supply of power may also be prevented from being delayed due to a response speed of the temperature measuring unit 410.

The determining unit 430 may determine the on/off chopping rate of the power to be supplied to the heater lamp 460 according to the number of sheets printed since a cold start occurred, along with a temperature measured by the temperature measuring unit 410 and a result output from the temperature rising/falling deciding unit 420. This number is output from the counter 470 for counting the number of sheets printed.

More specifically, the determining unit 430 receives the number of sheets printed, and determines whether the number is below a predetermined number. Preferably, the predetermined number is about 5. The predetermined number may be determined differently according to a fusing property for each sheet that is to be printed, which is within the scope of exemplary embodiments of the present invention.

When the number of sheets printed is below the predetermined number, the determining unit 430 determines the on/off chopping rate of the temperature-falling time period to be above the on/off chopping rate of the temperature-rising time period. FIG. 6 illustrates situations in which the number of sheets printed is less than 5. During the temperature-rising time period, the on/off chopping rate is determined to be 0%, X %, Y %, or Z % according to a temperature range, and during the temperature-falling time period, the on/off chopping rate is determined to be K %, I %, J %, or Z % according to a temperature range.

When the number of sheets printed exceeds the predetermined number, the determining unit 430 determines the on/off chopping rate according to the temperature measured by the temperature measuring unit 410 irrespective of whether the temperature is rising or falling. For example, when the number of sheets printed exceeds 5, a result output from the temperature rising/falling deciding unit 420 is ignored, and the on/off chopping rate is determined to be 0%, X %, Y %, or Z % according to which temperature range the above temperature belongs.

Meanwhile, the determining unit 430 may determine the on/off chopping rate of power to be supplied to the heater lamp 460 according to an elapsed time after a specific target temperature required for fusing is reached. This measurement is output from the timer 480, along with a temperature measured by the temperature measuring unit 410 and a result output from the temperature rising/falling deciding unit 420.

More specifically, the determining unit 430 receives the elapsed time value, and determines whether the elapsed time is within a predetermined time. The predetermined time is determined as a time required for the fusing temperature to stabilize after reaching the fusing target temperature. The predetermined time may vary depending on the capacity of the heater lamp, the thermal capacity of the heat roller, and the number of sheets printed per minute.

When the elapsed time is within the predetermined time, the determining unit 430 determines the on/off chopping rate of the temperature-falling time period to be above the on/off chopping rate of the temperature-rising time period. For example, as illustrated in FIG. 6, the on/off chopping rate is determined to be 0%, X %, Y %, or Z % according to a temperature range, and in the temperature-falling time period, the on/off chopping rate is determined to be K %, I %, J %, or Z % according to a temperature range.

When the elapsed time exceeds the predetermined time, the determining unit 430 determines the on/off chopping rate according to the temperature measured by the temperature measuring unit 410 regardless of whether the temperature is rising or falling. For example, a result output from the temperature rising/falling deciding unit 420 is ignored, and the on/off chopping rate is determined to be 0%, X %, Y %, or Z % according to the temperature range in which the above temperature belongs.

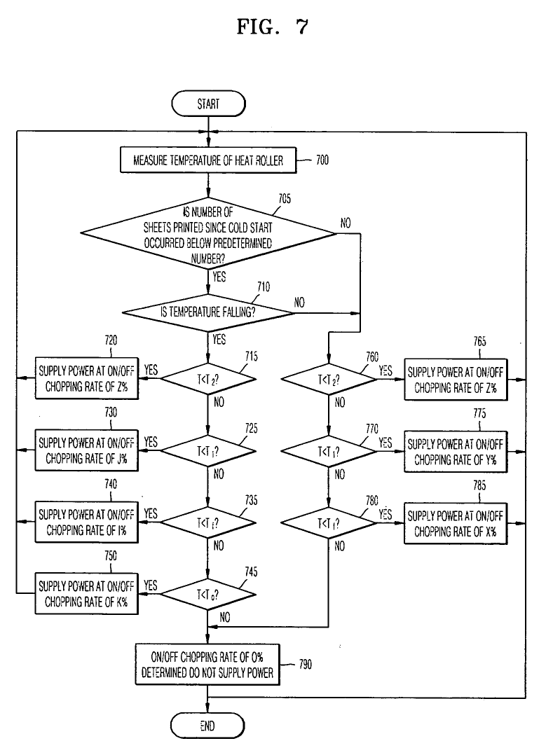

FIG. 7 is a flowchart of a method of controlling a fusing temperature according to an exemplary embodiment of the present invention. Referring to FIG. 7, the method of controlling a fusing temperature includes operations which are processed sequentially in the apparatus for controlling a fusing temperature illustrated in FIG. 4. Therefore, the descriptions of the apparatus for controlling a fusing temperature, as illustrated in FIG. 4, are applied to the method of controlling fusing temperature according to the an exemplary embodiment of the present invention.

In step 700, the temperature measuring unit 410 measures the surface temperature of the heat roller 450.

In step 705, the determining unit 430 determines whether the number of sheets printed since a cold start occurred is below a predetermined number. Preferably, the predetermined number is about 5. Of course, the predetermined number may be determined differently according to a fusing property for each sheet that is to be printed, which is within the scope of exemplary embodiments of the present invention. In step 705, if the number of sheets printed since a cold start occurred and is determined to be below the predetermined number, step 710 is performed. Otherwise, step 760 is performed.

In step 710, the temperature rising/falling deciding unit 420 determines whether the temperature of the heat roller 450 is falling. If the temperature of the heat roller 450 is determined to be falling in step 710, step 715 is performed. Otherwise, step 760 is performed.

An on/off chopping rate of power supplied to the heater lamp 460 in steps 715 to 750, and in steps 760 to 790, as illustrated in FIG. 7, is determined according to the table illustrated in FIG. 5.

In step 715, the determining unit 430 determines whether the surface temperature T of the heat roller is less than a temperature T2. If the surface temperature T is determined to be less than the temperature T2 in step 715, step 720 is performed, and thus the power supply 440 supplies power to the heater lamp 460 at the on/off chopping rate of Z %. Otherwise, step 725 is performed.

In step 725, the determining unit 430 determines whether the surface temperature T of the heat roller 450 is less then the temperature T1. If the surface temperature T is less than the temperature T1 in step 725, step 730 is performed, and thus the power supply 440 supplies power to the heater lamp 460 at the on/off chopping rate of J % Otherwise, step 735 is performed.

In step 735, the determining unit 430 determines whether the surface temperature T of the heat roller 450 is less then a fusing target temperature Tf. If the surface temperature T is determined to be less than the fusing target temperature Tf in step 735, step 740 is performed, and thus the power supply 440 supplies power to the heater lamp 460 at the on/off chopping rate of I %. Otherwise, step 745 is performed.

In step 745, the determining unit 430 determines whether the surface temperature T of the heat roller 450 is less then a temperature T0. If the surface temperature T is determined to be less than the temperature T0 in step 745, step 750 is performed, and thus the power supply 440 supplies power to the heater lamp 460 at the on/off chopping rate of K %. Otherwise, step 790 is performed.

In step 790, the on/off chopping rate is determined to be 0%, and the power supply 440 does not supply power to the heater lamp 460.

In step 760, the determining unit 430 determines Whether the surface temperature T of the heat roller 450 is less then a temperature T2. If the surface temperature T is determined to be less than the temperature T2 in step 760, step 765 is performed, and thus the power supply 440 supplies power to the heater lamp 460 at the on/off chopping rate of Z %. Otherwise, step 770 is performed.

In step 770, the determining unit 430 determines whether the surface temperature T of the heat roller 450 is less then a temperature T1. If the surface temperature T is determined to be less than the temperature T1 in step 770, step 775 is performed, and thus the power supply 440 supplies power to the heater lamp 460 at the on/off chopping rate of Y %. Otherwise, step 780 is performed.

In step 780, the determining unit 430 determines whether the surface temperature T of the heat roller 450 is less then a fusing target temperature Tf. If the surface temperature T is determined to be less than the fusing target temperature Tf in step 780, step 785 is performed, and thus the power supply 440 supplies power to the heater lamp 460 at the on/off chopping rate of X %. Otherwise, step 790 is performed.

While printing is carried out, each operation, in which the supply of power is achieved at on/off chopping rates of 0% through to a specific rate, is carried out, and thereafter the aforementioned operations are repeated, by repeatedly returning to step 700.

Operations to determine whether the number of sheets printed since a cold start occurred is below a predetermined number exits. However, step 705 may be replaced with an operation in which the determining unit 430 determines whether an elapsed time after the temperature of the heat roller 450 reaches a predetermined target temperature required for fusing is within a predetermined time. In this operation, if the elapsed time is determined to be within the predetermined time, step 710 is performed. Otherwise, step 760 is performed.

According to an exemplary embodiment of the present invention, power is supplied to a heater lamp at on/off chopping rates greater during a time period in which the temperature of the heat roller is rising than during a time period in which the temperature of the heat roller is falling, and thus a fusing property can be prevented from degrading in an initial printing process after a cold start occurs in a fusing unit. In particular, the fusing property can be ensured by two to five sheets of paper after overshoot occurs. According to an exemplary embodiment of the present invention, the fusing property is prevented from degrading in an initial printing process after a cold start occurs, and thus a first print out time (FPOT) can be reduced when a heater lamp that consumes relatively high power or a plurality of heater lamps are used.

The present invention can also be embodied as computer readable codes on a computer readable recording medium. The computer readable recording medium is an data storage device that can store data which can thereafter be read by a computer system. Examples of the computer readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer readable recording medium can also be distributed over network-coupled computer systems so that the computer readable code is stored and executed in a distributed fashion. Also, functional programs, codes and code segments for accomplishing the present invention can be easily construed as within the scope of the invention by programmers skilled in the art to which the invention pertains.

While the present invention has been particularly shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of controlling a fusing temperature of a fusing unit that comprises a heat roller which transmits heat to a toner image formed on a printing medium and a heat source which is comprised inside the heat roller and to which power is supplied, the method comprising:
supplying power to the heat source at on/off chopping rates determined according to the temperature of the heat roller during a time period in which the temperature of the heat roller is rising; and
supplying power to the heat source at on/off chopping rates which are respectively increased by a value with respect to the determined on/off chopping rates, during a time period in which the temperature of the heat roller is falling.

2. The method of controlling a fusing temperature of claim 1, wherein, in the supplying of power to the heat source at on/off chopping rates determined according to the temperature of the heat roller during a time period in which the temperature of the heat roller is rising, the on/off chopping rates are determined to be decreased as the temperature of the heat roller increases.

3. The method of controlling fusing temperature of claim 1, wherein, in the supplying of power to the heat source at on/off chopping rates which are respectively increased by a value with respect to the determined on/off chopping rates, during a time period in which the temperature of the heat roller is falling, the on/off chopping rates are determined to be increased as the temperature of the heat roller decreases.

4. The method of controlling a fusing temperature of claim 1, wherein, in the supplying of power to the heat source at on/off chopping rates determined according to the temperature of the heat roller during a time period in which the temperature of the heat roller is rising, when the temperature of the heat roller is above a target temperature required for fusing, power is not supplied to the heat source.

5. The method of controlling fusing temperature of claim 1, wherein, in the supplying of power to the heat source at on/off chopping rates which are respectively increased by a value with respect to the determined on/off chopping rates, during a time period in which the temperature of the heat roller is falling, when the temperature of the heat roller is between the target temperature required for fusing and a temperature greater than the target temperature, power is supplied to the heat source according to an on/off chopping rate.

6. The method of controlling a fusing temperature of claim 1, wherein, in the supplying of power to the heat source at on/off chopping rates which are respectively increased by a value with respect to the determined on/off chopping rates, during a time period in which the temperature of the heat roller is falling, power is supplied to the heat source at the increased on/off chopping rates only when the number of sheets printed since a cold start occurred in the fusing unit is within a number.

7. The method of controlling a fusing temperature of claim 1, wherein, in the supplying of power to the heat source at on/off chopping rates which are respectively increased by a value with respect to the determined on/off chopping rates, during a time period in which the temperature of the heat roller is falling, power is supplied to the heat source at the increased on/off chopping rates only when an elapsed time after the temperature of the heat roller reaches the target temperature required for fusing is within a reference time.

8. An apparatus for controlling fusing temperature of a fusing unit that comprises a heat roller which transmits heat to a toner image formed on a printing medium and a heat source which is comprised inside the heat roller and to which power is supplied, the apparatus comprising:
a determining unit for determining on/off chopping rates according to the temperature of the heat roller during a time period in which the temperature of the heat roller is rising, and determines on/off chopping rates to be respectively increased by a value with respect to the determined on/off chopping rates during a time period in which the temperature of the heat roller is falling; and
a power supply for supplying power to the heat source according to the determined on/off chopping rates.

9. The apparatus for controlling a fusing temperature of claim 8, wherein the determining unit determines the on/off chopping rates to be decreased as the temperature of the heat roller increases during a time period in which the temperature of the heat roller is rising.

10. The apparatus for controlling fusing temperature of claim 8, wherein the determining unit determines the on/off chopping rates to be increased when the temperature of the heat roller decreases during a time period in which the temperature of the heat roller is falling.

11. The apparatus for controlling a fusing temperature of claim 8, wherein the determining unit determines an on/off chopping rate to be 0% as the temperature of the heat roller is above the target temperature required for fusing, during a time period in which the temperature of the heat roller is rising.

12. The apparatus for controlling a fusing temperature of claim 8, wherein the determining unit determines an on/off chopping rate to be a specific rate when the temperature of the heat roller is between the target temperature required for fusing and a temperature greater than the target temperature.

13. The apparatus for controlling a fusing temperature of claim 8, further comprising a counter that counts the number of sheets printed since a cold start occurred in the fusing unit, wherein the determining unit determines the increased on/off chopping rates only when the number of sheets printed is below a number.

14. The apparatus for controlling fusing temperature of claim 8, further comprising a timer that outputs the length of an elapsed time after the temperature of the heat roller reaches the target temperature required for fusing, wherein the determining unit determines the increased on/off chopping rates only when the elapsed time is within a reference time.

15. An image forming apparatus for controlling a fusing temperature of a fusing unit that comprises a heat roller which transmits heat to a toner image formed on a printing medium and a heat source which is comprised inside the heat roller and to which power is supplied, the apparatus comprising:
a determining unit for determining on/off chopping rates according to the temperature of the heat roller during a time period in which the temperature of the heat roller is rising, and determines on/off chopping rates to be respectively increased by a value with respect to the determined on/off chopping rates during a time period in which the temperature of the heat roller is falling; and
a power supply for supplying power to the heat source according to the determined on/off chopping rates.

16. The image forming apparatus of claim 15, wherein:
the determining unit determines the on/off chopping rates to be decreased when the temperature of the heat roller increases during a time period in which the temperature of the heat roller is rising; and
the determining unit determines the on/off chopping rates to be increased when the temperature of the heat roller decreases during a time period in which the temperature of the heat roller is falling.

17. The image forming apparatus of claim 15, wherein the determining unit determines an on/off chopping rate to be 0% when the temperature of the heat roller is above the target temperature required for fusing, during a time period in which the temperature of the heat roller is rising.

18. The image forming apparatus of claim 15, wherein the determining unit determines an on/off chopping rate to be a specific rate when the temperature of the heat roller is between the target temperature required for fusing and a temperature greater than the target temperature.

19. The image forming apparatus of claim 15, further comprising a counter that counts the number of sheets printed since a cold start occurred of the image forming apparatus, wherein the determining unit determines the increased on/off chopping rates only when the number of sheets printed is below a number.

20. The image forming apparatus of claim 15, further comprising a timer that outputs the length of an elapsed time after the temperature of the heat roller reaches the target temperature required for fusing, wherein the determining unit determines the increased on/off chopping rates only when the elapsed time is within a reference time.

21. An apparatus for controlling fusing temperature of claim 13, further comprising a timer that outputs the length of an elapsed time after the temperature of the heat roller reaches the target temperature required for fusing, wherein the determining unit determines the increased on/off chopping rates only when the elapsed time is within a reference time.

22. A computer readable medium having stored thereon a computer program for executing a method of controlling a fusing temperature of a fusing unit that comprises a heat roller which transmits heat to a toner image formed on a printing medium and a heat source which is comprised inside the heat roller and to which power is supplied, the method comprising:
a first set of instructions for supplying power to the heat source at on/off chopping rates determined according to the temperature of the heat roller during a time period in which the temperature of the heat roller is rising; and a second set of instructions for supplying power to the heat source at on/off chopping rates which are respectively increased by a value with respect to the determined on/off chopping rates, during a time period in which the temperature of the heat roller is falling.
